(19) United States
(12) Patent Application Publication
(10) Pub. No.: US 2008/0260054 A1
(43) Pub. Date: Oct. 23, 2008

(54) METHOD AND APPARATUS FOR REDUCING A PEAK-TO-AVERAGE POWER RATIO IN A MULTIPLE-INPUT MULTIPLE-OUTPUT SYSTEM

(75) Inventors: Hyung G. Myung, New York, NY (US); Kyle Jung-Lin Pan, Smithtown, NY (US); Robert Lind Olesen, Huntington, NY (US); Donald M. Grieco, Manhasset, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/839,773

(22) Filed: Aug. 16, 2007

Related U.S. Application Data
(60) Provisional application No. 60/838,254, filed on Aug. 17, 2006.

(51) Int. Cl. H04L 27/28

(52) U.S. Cl. 375/260

(57) ABSTRACT

A method and apparatus for reducing a peak-to-average power ratio (PAPR) in a multiple-input multiple-output (MIMO) wireless communication system are disclosed. Transmit beamforming or precoding is performed on transmit symbols based on a channel matrix. For feedback, channel matrices may be averaged over multiple subcarriers and the averaged channel matrices may be further quantized. In order to reduce the PAPR, amplitude clipping may be performed on the symbols after the transmit processing. The amplitude clipping may be performed by hard clipping, soft clipping, or smooth clipping.

### CROSS REFERENCE TO RELATED APPLICATION

This application claims the benefit of U.S. Provisional Application No. 60/838,254 filed Aug. 17, 2006, which is incorporated by reference as if fully set forth.

### FIELD OF INVENTION

The present invention is related to wireless communication systems. More particularly, the present invention is related to a method and apparatus for reducing a peak-to-average power ratio (PAPR) in a multiple-input multiple-output (MIMO) wireless communication system.

### BACKGROUND

Single carrier frequency division multiple access (SC-FDMA) has been adopted for the uplink multiple access scheme for the third generation partnership project (3GPP) long term evolution (LTE), or evolved universal terrestrial radio access (E-UTRA). One prominent advantage over orthogonal frequency division multiple access (OFDMA) is that the SC-FDMA signal has lower PAPR because of its inherent single carrier structure. A MIMO scheme offers an attractive way to significantly increase the peak data rate for wireless communication using SC-FDMA. Among various MIMO techniques, precoding or transmit eigen-beamforming (TxBF) is a promising technique that provides many benefits. However, the use of precoding or TxBF may change the properties of SC-FDMA signals, such as a PAPR. Transmit precoding or TxBF tends to increase the PAPR because each antenna signal becomes a composite signal due to spatial processing of multiple streams.

FIG. 1 shows a conventional wireless communication system 100 implementing TxBF. The wireless communication system 100 includes a transmitter 110 and a receiver 120. For TxBF, the receiver 120 estimates a channel matrix, \check{H}. The estimated channel matrix can be decomposed using singular value decomposition (SVD) or an equivalent operation as follows:

\check{H}=UDV^{H}; Equation (1)

where U and V are unitary matrices, and D is a diagonal matrix. The receiver 120 sends the V matrix to the transmitter 110. The transmitter 110 then applies the V matrix to data S for precoding or TxBF.

The two dimensional transform for the data S may be expressed as follows:

X=TS; Equation (2)

where the matrix T is a generalized transform matrix. When TxBF is performed, the transform matrix T is the unitary preceding matrix V, (i.e., T=V). The transmitted signal X goes through the channel and noise N is added. The receiver 120 processes the received signal Y=HX+N, (for example, using a linear minimum mean square error (LMMSE)), to output a signal Z.

In terms of transmit signal in the time domain, applying a preceding matrix in the frequency domain is equivalent to the convolution and summation of the data symbols in the time domain. Thus, TxBF increases the PAPR of the transmitted signal.

Therefore, it would be desirable to reduce the PAPR when implementing TxBF in a MIMO system for SC-FDMA.

### SUMMARY

The present invention is related to a method and apparatus for reducing a PAPR in a MIMO wireless communication system. Transmit beamforming or precoding is performed on transmit symbols based on a channel matrix. For feedback, channel matrices may be averaged over multiple subcarriers and the averaged channel matrices may be further quantized. In order to reduce the PAPR, amplitude clipping may be performed on the symbols after the transmit processing. The amplitude clipping may be performed by hard clipping, soft clipping, or smooth clipping.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a conventional wireless communication system implementing TxBF;

FIG. 2 shows a wireless communication system implementing TxBF in accordance with one embodiment of the present invention;

FIG. 3 shows simulation results for comparing PAPR characteristics of various MIMO TXBF signals;

FIG. 4 shows simulation results for comparing PAPR characteristics of different MIMO schemes;

FIG. 5 shows an input-output transfer characteristic for symbol amplitude clipping;

FIG. 6 is a block diagram of a transmitter configured in accordance with the present invention;

FIG. 7 shows a complementary cumulative distribution function (CCDF) of the PAPR of the symbols processed in accordance with the present invention;

FIG. 8 shows a raw bit error rate (BER) performance when clipping is applied in accordance with the present invention;

FIG. 9 shows a frame error rate (FER) performance when clipping is applied in accordance with the present invention; and

FIG. 10 shows a frequency spectrum of the clipped signals in accordance with the present invention.

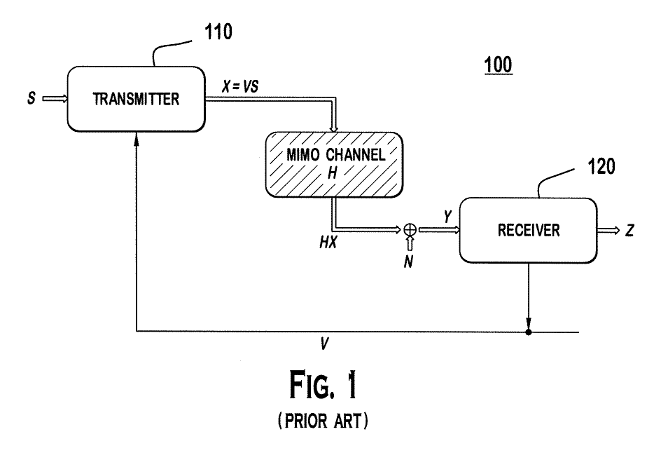

### DETAILED DESCRIPTION OF THE PREFERRED EMBODIMENTS

When referred to hereafter, the terminology “transmitter” and “receiver” include but are not limited to a wireless transmit/receive unit (WTRU), a user equipment (UE), a mobile station, a fixed or mobile subscriber unit, a pager, a cellular telephone, a personal digital assistant (PDA), a computer, or any other type of user device capable of operating in a wireless environment, and a base station, a Node-B, a site controller, an access point (AP), or any other type of interfacing device capable of operating in a wireless environment.

The present invention is applicable to any wireless communication system implementing MIMO including, but not limited to, an SC-FDMA system.

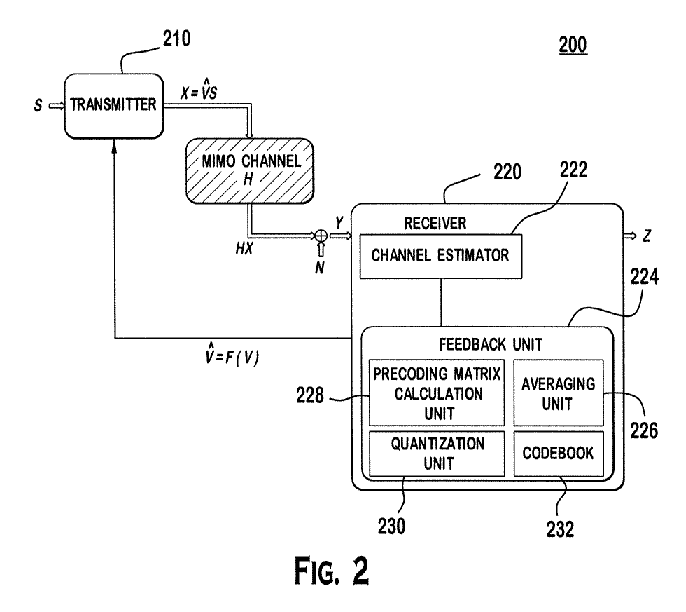

FIG. 2 shows a wireless communication system 200 implementing TxBF in accordance with one embodiment of the present invention. The system includes a transmitter 210 and a receiver 220. The receiver 220 includes a channel estimator 222 and a feedback unit 224. The feedback unit 224 may include an averaging unit 226 (optional), a precoding matrix calculation unit 228, a quantization unit 230 (optional) and a codebook 232 (optional).

For TxBF, the channel estimator 222 estimates a channel matrix, \check{H}, for a plurality of subcarriers, and the feedback unit 224 sends feedback to the transmitter 210. In order to reduce feedback overhead, the averaging unit 226 may average the channel matrix over multiple subcarriers. The precoding matrix calculation unit 228 computes the precoding matrix \hat{V} from the averaged channel matrix (or not averaged channel matrix) using SVD or equivalent operation as per Equation (1). The feedback unit 224 sends the precoding matrix \hat{V} generated from the averaged channel matrix to the transmitter 210 for TxBF or precoding. The quantization unit 230 may quantize the precoding matrix \hat{V} and send the quantized preceding matrix, {circumflex over (\hat{V}. Alternatively, the feedback unit 224 may select a unitary precoding matrix from the codebook 232 based on the (averaged) channel matrix and sends an index to the selected unitary preceding matrix to the transmitter 210 for TxBF or precoding. The (non-quantized) channel matrix is used to compute a metric for each precoding vector from the codebook and an index to the codebook with the largest metric is fed back to the transmitter 210. If the codebook is a non-unitary one, the feedback unit 224 may select a non-unitary preceding matrix from the codebook 232 based on the (averaged) channel matrix and sends an index to the selected non-unitary precoding matrix to the transmitter 210 for TxBF or precoding.

After TxBF or preceding, the transmitted signal may be expressed as follows:

X=\hat{V}S, (or X={circumflex over (\hat{V}S). Equation (3)

The transmitter 210 applies the \hat{V} or {circumflex over (\hat{V} matrix to data S. The transmitted signal X goes through the channel and a noise N is added. The receiver 120 processes the received signal Y=HX+N, (e.g., using an LMMSE), to output a signal Z.

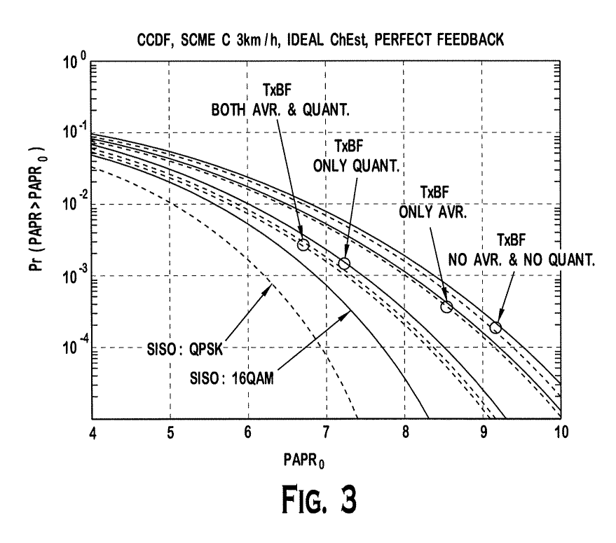

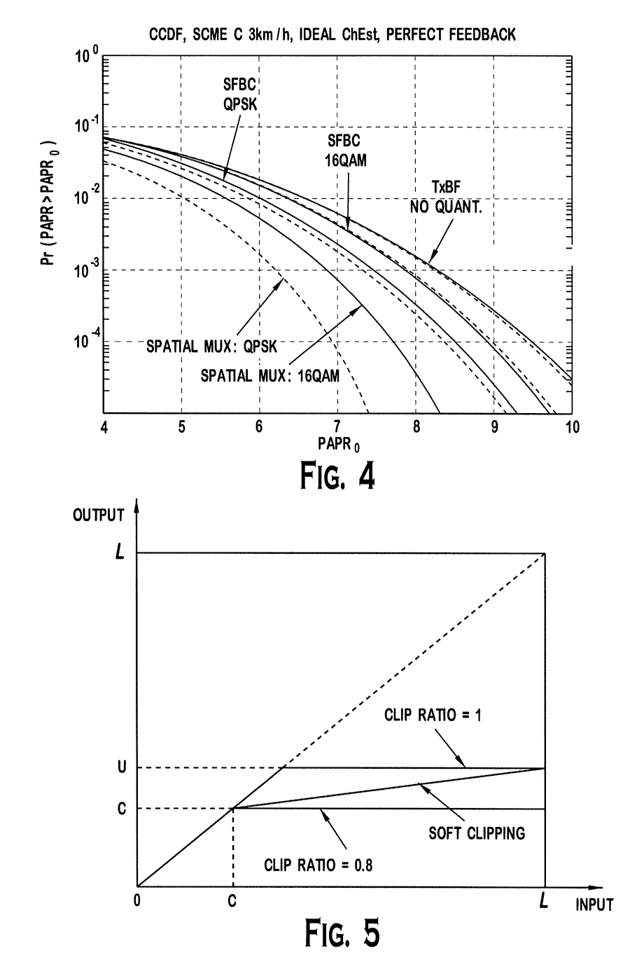

FIG. 3 shows simulation results for comparing PAPR characteristics of various MIMO TxBF signals, and FIG. 4 shows simulation results for comparing PAPR characteristics of different MIMO schemes. Parameters and assumptions used for the simulations summarized in Table 1.

TABLE 1

| Parameter | Assumption |
|---|---|
| Carrier frequency | 2.0 GHz |
| Symbol rate | 7.68 million symbols/sec |
| Transmission bandwidth | 5 MHz |
| Transmission time interval | 0.5 ms |
| (TTI) length | |
| Number of data blocks per TTI | 6 long blocks (LBs) |
| Number of occupied subcarriers | 128 |
| per LB | |
| FET block size | 512 |
| Cyclic prefix (CP) length | 32 samples |
| Subcarrier mapping | Distributed |
| Pulse shaping | Time domain root raised cosine (RRC) |
| | filter (rolloff = 0.22) |
| Oversampling | 4 times oversampling |
| Channel model | SCME C, 3 km/h |
| Antenna configurations | 2 × 2 (MIMO) |
| Data modulation | Quadrature phase shift keying |
| | (QPSK) and 16 quadrature amplitude |
| | modulation (QAM) |
| Channel coding | Turbo code with R = ⅓ |
| Equalizer | LMMSE |
| Feedback error | None |
| Channel Estimation | Perfect channel estimation |

In the simulations, the channel matrix H is averaged over 25 continuous subcarriers. For quantization, direct quantization of the precoding matrix V using 3 bits, (1 bit for amplitude and 2 bits for phase information), is performed. As shown in FIG. 3, without averaging the channel matrix and quantization of the precoding matrix, the MIMO TxBF signal has 1.5˜2 dB higher PAPR with respect to single antenna transmission. When averaging and quantization are performed, the PAPR is decreased by 0.8˜0.9 dB and the MIMO TxBF has about 0.7 to 1.1 dB higher PAPR with respect to single antenna transmission.

FIG. 4 shows the PAPR of different MIMO schemes. Since there is no preceding or spatial processing at the transmitter for spatial multiplexing (SM), SM has the same PAPR as single antenna transmission. Without quantization for the precoding matrix, TxBF has a higher PAPR than space frequency block coding (SFBC) by 0.5˜1 dB. TxBF and SFBC have a similar PAPR when quantization of the preceding matrix is performed.

In accordance with another embodiment of the present invention, the symbol amplitude, (i.e., the peak power), is clipped to reduce the PAPR. The problems associated with clipping are in-band signal distortion and generation of out-of-band interferences. In an SC-FDMA system, because SC-FDMA modulation spreads information data across all the modulated symbols, the in-band signal distortion is mitigated when an SC-FDMA symbol is clipped. To mitigate the out-of-band interference, some form of soft clipping may be used. One example is to clip the signal amplitude according to the input-output transfer characteristics of soft clipping as shown in FIG. 5. Other forms of soft clipping, hard clipping, or smooth clipping may also be used. The clipping may be performed before pulse shaping, after pulse shaping, or both.

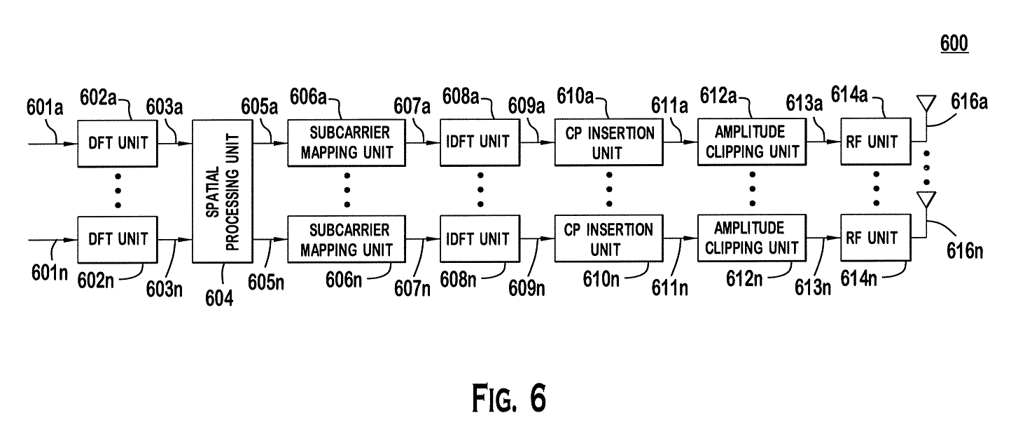

FIG. 6 is a block diagram of a transmitter 600 configured in accordance with the present invention. The transmitter 600 includes a plurality of discrete Fourier transform (DFT) units 602a-602n, a spatial processing unit 604, a plurality of subcarrier mapping units 606a-606n, a plurality of inverse discrete Fourier transform (IDFT) units 608a-608n, a plurality of cyclic prefix (CP) insertion units 610a-610n, a plurality of amplitude clipping units 612a-612n, a plurality of radio frequency (RF) units 614a-614n, and a plurality of antennas 616a-616n.

Multiple streams of input data 601a-601n are processed by the DFT units 602a-602n. The DFT processed data 603a-603n are processed by the spatial processing unit 604 for TXBF, spatial multiplexing (SM), or the like. The data 605a-605n in each data stream is then mapped to subcarriers by the corresponding subcarrier mapping units 606a-606n. The subcarrier mapped data 607a-607n in each data stream is then processed by the corresponding IDFT unit 608a-608n to be converted to time domain data 609a-609n. A CP is then added to the time domain data 609a-609n in each data stream by the CP insertion units 610a-610n. The time domain data with CP 611a-611n in each data stream is then processed by the amplitude clipping units 612a-612n for amplitude clipping. After amplitude clipping, the amplitude-clipped data 613a-613n in each data stream is then processed by the RF units 614a-614n and transmitted via the antennas 616a-616n. As stated above, the amplitude clipping may be performed before and/or after pulse shaping.

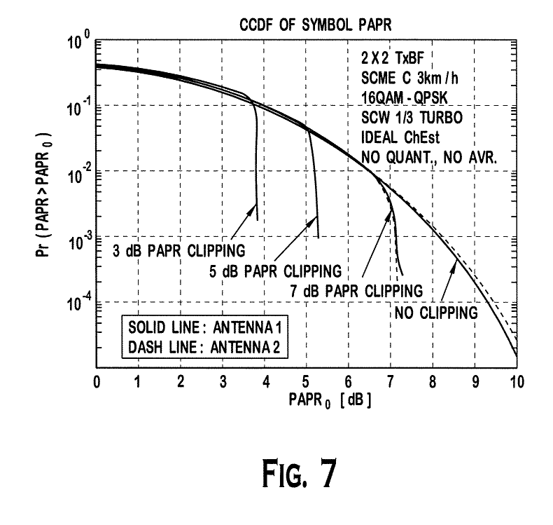

FIGS. 7-9 show simulation results for clipping applied to 2×2 uplink TxBF MIMO scheme. For the simulations, a hard clipping for the symbol amplitude clipping is applied. However, as stated hereinbefore, the clipping may be any forms of clipping.

FIG. 7 shows a complementary cumulative distribution function (CCDF) of the PAPR of the symbols processed in accordance with the present invention. The CCDF is a probability that the PAPR of a data block exceeds a given threshold. Clipping is performed at various levels as shown in FIG. 7. The simulation results show that even with as much as 3 dB PAPR clipping, only about 10% of the modulated symbols are clipped.

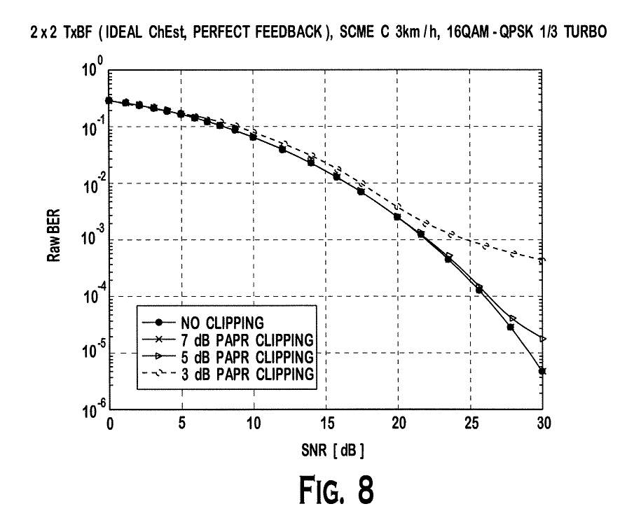

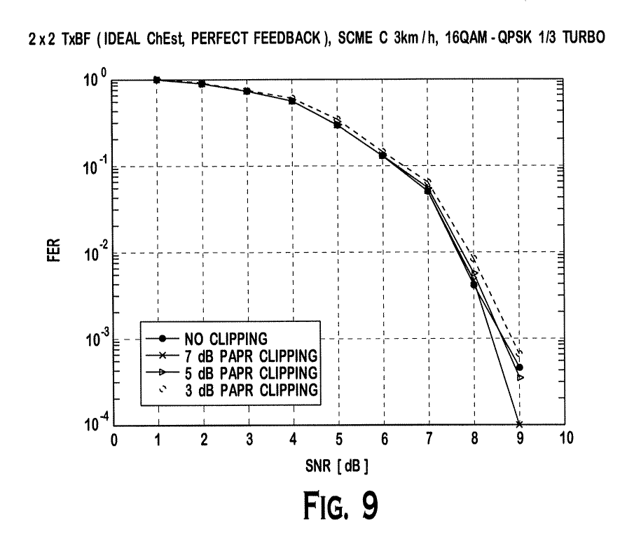

FIGS. 8 and 9 show the link level performance, (raw BER and FER), when clipping is applied in accordance with the present invention. The simulation results show that the performance degradation due to clipping is minimal when clipping at 7 dB above the average power. The performance degrades slightly more when clipping at 3 or 5 dB above the average power.

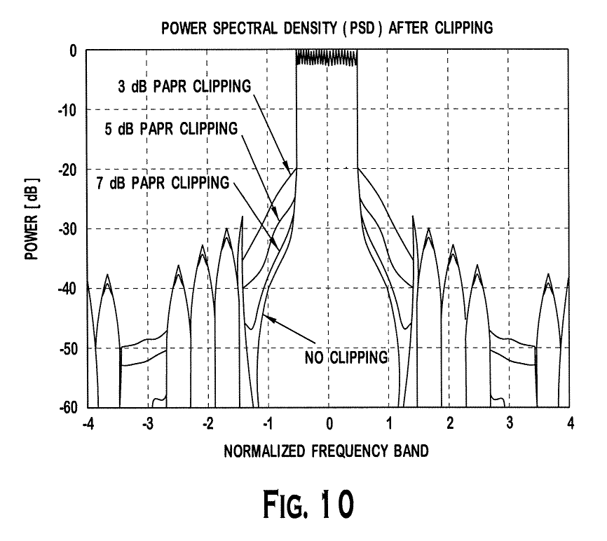

Clipping will generate both in-band and out-of-band frequency components. FIG. 10 shows the frequency spectrum of the clipped signals by power spectral density (PSD). For PSD calculation, a Hanning window was used with ¼ of window overlapping. For 7 dB PAPR clipping, the spectrum is almost the same as that of the original signal. More pronounced out-of-band components arise when 5 or 3 dB PAPR clipping is used. It is clear that 7 dB clipping has minimal impact on the power spectrum.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for reducing a peak-to-average power ratio (PAPR) in a multiple-input multiple-output (MIMO) wireless communication system, the method comprising:
estimating a channel matrix;
performing a transmit processing on symbols to be transmitted based on the channel matrix; and
performing an amplitude clipping on the symbols after the transmit processing.

2. The method of claim 1 wherein the amplitude clipping is performed by hard clipping.

3. The method of claim 1 wherein the amplitude clipping is performed by soft clipping.

4. The method of claim 1 wherein the amplitude clipping is performed by smooth clipping.

5. The method of claim 1 wherein the amplitude clipping is performed before processing the symbols via a pulse shaping filter.

6. The method of claim 1 wherein the amplitude clipping is performed after processing the symbols via a pulse shaping filter.

7. The method of claim 1 wherein the amplitude clipping is performed both before and after processing the symbols via a pulse shaping filter.

8. The method of claim 1 wherein the wireless communication system is a single carrier frequency division multiple access (SC-FDMA) system.

9. A method for reducing a peak-to-average power ratio (PAPR) in a multiple-input multiple-output (MIMO) wireless communication system, the method comprising:
a receiver estimating channel matrices for a plurality of subcarriers;
the receiver averaging the channel matrices over multiple subcarriers;
the receiver generating a transmit precoding vector from the averaged channel matrix;
the receiver sending the transmit precoding vector to a transmitter; and
the transmitter performing a transmit processing on symbols to be transmitted using the transmit precoding vector.

10. The method of claim 9 further comprising:
the receiver quantizing the averaged channel matrices, wherein the transmit precoding matrix is generated based on the quantized channel matrices.

11. The method of claim 10 wherein the receiver selects a unitary precoding matrix from a codebook based on the averaged channel matrix, and sends an index to the selected unitary precoding matrix to the transmitter.

12. A method for reducing a peak-to-average power ratio (PAPR) in a multiple-input multiple-output (MIMO) wireless communication system, the method comprising:
a receiver estimating a channel matrix;
the receiver quantizing the channel matrix;
the receiver generating a transmit precoding matrix from the quantized channel matrix;
the receiver sending the transmit preceding matrix to a transmitter; and
the transmitter performing a transmit processing on symbols to be transmitted using the transmit precoding matrix.

13. The method of claim 12 wherein the receiver selects a unitary precoding matrix from a codebook based on the channel matrix, and sends an index to the selected unitary precoding matrix to the transmitter.

14. A transmitter for reducing a peak-to-average power ratio (PAPR) in a multiple-input multiple-output (MIMO) wireless communication system, the transmitter comprising:
a spatial processor for performing a transmit processing on symbols to be transmitted based on a channel matrix; and
an amplitude clipper for performing an amplitude clipping on the symbols after the transmit processing.

15. The transmitter of claim 14 wherein the amplitude clipping is performed by hard clipping.

16. The transmitter of claim 14 wherein the amplitude clipping is performed by soft clipping.

17. The transmitter of claim 14 wherein the amplitude clipping is performed by smooth clipping.

18. The transmitter of claim 14 further comprising:
a pulse shaping filter, wherein the amplitude clipping is performed before processing the symbols via the pulse shaping filter.

19. The transmitter of claim 14 further comprising:
a pulse shaping filter, wherein the amplitude clipping is performed after processing the symbols via the pulse shaping filter.

20. The transmitter of claim 14 further comprising:
a pulse shaping filter, wherein the amplitude clipping is performed both before and after processing the symbols via a pulse shaping filter.

21. The transmitter of claim 14 wherein the wireless communication system is a single carrier frequency division multiple access (SC-FDMA) system.

22. A receiver for reducing a peak-to-average power ratio (PAPR) in a multiple-input multiple-output (MIMO) wireless communication system, the receiver comprising:
a channel estimator for estimating channel matrices for a plurality of subcarriers; and
a feedback unit comprising:
an averaging unit for averaging the channel matrices over multiple subcarriers; and
a transmit preceding matrix calculation unit for calculating a transmit precoding matrix from the averaged channel matrix, wherein the feedback unit sends the transmit precoding matrix to a transmitter so that the transmitter performs transmit processing using the transmit precoding matrix.

23. The receiver of claim 22 wherein the feedback unit further comprises:
a quantizer for quantizing the averaged channel matrices, wherein the transmit precoding matrix calculation unit calculates the transmit precoding matrix from the quantized averaged channel matrix.

24. The receiver of claim 23 wherein the feedback unit further comprises:
a codebook,
wherein the feedback unit, based on the averaged channel matrix, selects a unitary precoding matrix from the codebook and sends an index to the selected unitary precoding matrix to the transmitter.

25. A receiver for reducing a peak-to-average power ratio (PAPR) in a multiple-input multiple-output (MIMO) wireless communication system, the receiver comprising:
a channel estimator for estimating a channel matrix; and
a feedback unit comprising:
a quantizer for quantizing the channel matrix; and
a transmit precoding matrix calculation unit for calculating a transmit precoding matrix from the quantized channel matrix, wherein the feedback unit sends the transmit preceding matrix to a transmitter so that the transmitter performs transmit processing using the transmit preceding matrix.

26. The receiver of claim 25 wherein the feedback unit further comprises:
a codebook,
wherein the feedback unit, based on the channel matrix, selects a unitary precoding matrix from the codebook and sends an index to the selected unitary preceding matrix to the transmitter.
